(19) United States
(12) Patent Application Publication
(10) Pub. No.: US 2023/0318425 A1
(43) Pub. Date: Oct. 5, 2023

(54) ACTUATOR

(71) Applicant: NIDEC SANKYO CORPORATION, Nagano (JP)

(72) Inventor: Masao TSUCHIHASHI, Nagano (JP)

(73) Assignee: NIDEC SANKYO CORPORATION, Nagano (JP)

(21) Appl. No.: 18/185,383

(22) Filed: Mar. 17, 2023

(30) Foreign Application Priority Data
Mar. 31, 2022 (JP) 2022-058015

(51) Int. Cl. H02K 33/18

(52) U.S. Cl. CPC H02K 33/18

(57) ABSTRACT

An actuator includes a movable body, a support body having a case and a coil holder, and a magnetic drive circuit having a coil and a magnet and structured to vibrate the movable body with respect to the support body. The coil holder has a first holder side plate part, and the case includes a first case member having a first end plate part which faces the movable body from one side. The first case member has a first side plate part which is extended from an end of the first end plate part and a first cut-and-raised part which is cut and raised from the first end plate part. An end part of the first holder side plate part of the coil holder is sandwiched and positioned between the first side plate part and the first cut-and-raised part.

### CROSS REFERENCE TO RELATED APPLICATION

The present invention claims priority under 35 U.S.C. § 119 to Japanese Application No. 2022-058015 filed Mar. 31, 2022, the entire content of which is incorporated herein by reference.

### TECHNICAL FIELD

At least an embodiment of the present invention may relate to an actuator structured to vibrate a movable body.

### BACKGROUND

Japanese Patent Laid-Open No. 2020-102901 (Patent Literature 1) discloses an actuator which includes a movable body having a magnet and a support body having a coil, and in which the movable body is vibrated with respect to the support body by supplying a drive electric current to the coil. Such an actuator uses an elastic body or a viscoelastic body as a connection body which connects a movable body with a support body. When the movable body is vibrated, a reaction force corresponding to the vibration of the movable body is applied to the support body through the connection body. As a result, a user who touches the support body is capable of bodily sensing the vibration.

In the actuator described in Patent Literature 1, a support body includes a case made of metal which defines an outer shape of the actuator and a coil holder made of resin. A coil is an air core coil which is disposed in a coil arrangement hole provided in the coil holder. A movable body includes a first yoke which faces the coil from one side and a second yoke which faces the coil from the other side, and a magnet is fixed to each of the first yoke and the second yoke.

In the actuator described in Patent Literature 1, a case includes a first case member which covers the coil holder from one side and a second case member which covers the coil holder from the other side. The coil holder is provided with a side plate part which is formed at an outer edge of a plate part provided with the coil arrangement hole. When the side plate part is attached to inner sides of the first case member and the second case member which are manufactured by bending a metal plate, the case and the coil holder are integrally assembled.

Conventionally, in an actuator having a case made of metal and a coil holder made of resin, dimensions of the case and the coil holder are designed so as to have a gap space between the case and the coil holder in consideration of dimensional tolerance of the parts so that assembling failure of the case and the coil holder does not occur. However, in this structure, rattling easily occurs between the case and the coil holder and thus, positional accuracy of the coil holder with respect to the case is lowered and vibration characteristics of the actuator may be varied. On the other hand, it is conceivable that rattling is prevented by press-fitting and positioning the coil holder to the case. However, in this case, a dimensional accuracy of an outer shape of the actuator may be lowered due to deformation of the case.

### SUMMARY

At least an embodiment of the present invention may advantageously provide an actuator in which rattling of a coil holder with respect to a case of the actuator is restrained, positional accuracy of the coil holder is enhanced, and lowering of accuracy of an outside dimension of the case is restrained.

According to at least an embodiment of the present invention, there may be provided an actuator including a movable body, a support body having a case which is made of metal and accommodates the movable body and a coil holder made of resin, a connection body which is connected with the movable body and the support body, and a magnetic drive circuit having a coil which is held by the coil holder and a magnet which faces the coil in a first direction, and the magnetic drive circuit is structured to vibrate the movable body with respect to the support body in a second direction intersecting the first direction. According to a direction intersecting the first direction and the second direction being referred to as a third direction, the coil holder is provided with a first holder side plate part which is extended in the first direction on one side in the third direction with respect to the coil, and the case includes a first case member having a first end plate part, which faces the movable body from one side in the first direction, and a second case member having a second end plate part which faces the movable body from the other side in the first direction. The first case member is provided with a first case-first side plate part which is extended from an end on one side in the third direction of the first end plate part to the other side in the first direction, and a first cut-and-raised part which is cut and raised to the other side in the first direction from the first end plate part on the other side in the third direction with respect to the first case-first side plate part. An end part on the one side in the first direction of the first holder side plate part is sandwiched between the first case-first side plate part and the first cut-and-raised part.

According to at least an embodiment of the present invention, the case of the actuator and the coil holder are positioned by sandwiching the side plate part (first holder side plate part) provided at an end in the third direction of the coil holder between the side plate part (first case-first side plate part) provided at an end in the third direction of the case and the first cut-and-raised part disposed on its inner side. Therefore, rattling in the third direction of the coil holder with respect to the case can be restrained. Further, the coil holder is positioned with the side plate part of the case as a reference and thus, positional accuracy in the third direction of the coil with respect to the case can be enhanced. In addition, the cut-and-raised part provided on an inner side of the case is used for positioning and thus, deformation of the side plate part (first case-first side plate part) of the case can be restrained when the coil holder is positioned. Therefore, lowering of accuracy of an outside dimension in the third direction of the case can be restrained.

In at least an embodiment of the present invention, one of the first holder side plate part and the first end plate part is provided with a first positioning protruded part which is protruded in the first direction, and the other of the first holder side plate part and the first end plate part is provided with a first positioning hole to which the first positioning protruded part is fitted. According to this structure, the protrusion and the hole are fitted to each other in the first direction and thus, rattling in the second direction of the coil holder with respect to the case can be restrained, and positional accuracy in the second direction of the coil holder with respect to the case can be enhanced. Further, a space in the second direction can be provided between the side plate part (first holder side plate part) of the coil holder and the case and thus, lowering of accuracy of an outside dimension in the second direction of the case can be restrained.

In at least an embodiment of the present invention, the coil holder includes a first holder member provided with a first coil holding part which is disposed on one side in the third direction with respect to the coil, and the first holder side plate part which is extended in the first direction from an end on the one side in the third direction of the first coil holding part, and a second holder member provided with a second coil holding part which is disposed on the other side in the third direction with respect to the coil, and a second holder side plate part which is extended in the first direction from an end on the other side in the third direction of the second coil holding part. The first case member is provided with a first case-second side plate part which is extended to the other side in the first direction from an end on the other side in the third direction of the first end plate part, and a second cut-and-raised part which is cut and raised from the first end plate part to the other side in the first direction on the one side in the third direction with respect to the first case-second side plate part. An end part on the one side in the first direction of the second holder side plate part is sandwiched between the first case-second side plate part and the second cut-and-raised part.

According to this structure, since the coil holder is divided into two parts in the third direction, portions covering both sides in the second direction of the coil are not required and thus, an outside dimension in the second direction of the actuator can be reduced. Alternatively, a size of the coil can be increased without increasing an outer shape of the actuator and thus, thrust of the magnetic drive circuit can be increased and large vibration is generated. Further, each of the first holder side plate part and the second holder side plate part is sandwiched and positioned between the side plate part of the case and the cut-and-raised part provided on its inner side at both ends in the third direction of the case. Therefore, even when the coil holder is divided into two parts, rattling in the third direction of the coil holder with respect to the cas e can be restrained, and positional accuracy in the third direction of the coil with respect to the case can be enhanced. Further, lowering of accuracy of an outside dimension in the third direction of the case can be restrained.

In at least an embodiment of the present invention, one of the second holder side plate part and the first end plate part is provided with a second positioning protruded part which is protruded in the first direction, and the other of the second holder side plate part and the first end plate part is provided with a second positioning hole to which the second positioning protruded part is fitted. According to this structure, rattling in the second direction of the first holder member and the second holder member with respect to the case can be restrained, and positional accuracy in the second direction of the first holder member and the second holder member with respect to the case can be enhanced. Further, lowering of accuracy of an outside dimension in the second direction of the case can be restrained.

In at least an embodiment of the present invention, the movable body includes a yoke which holds the magnet, the yoke includes a first facing part facing the coil from the one side in the first direction and a second facing part facing the coil from the other side in the first direction, the magnet is fixed to at least one of the first facing part and the second facing part, and the first cut-and-raised part and the second cut-and-raised part face the first facing part from both sides in the third direction to structure a first stopper part which restricts a movable range of the yoke in the third direction. According to this structure, the movable body is less likely to move largely in the third direction which is different from a vibration direction due to an impact such as falling to cause damage of the actuator. Further, the cut-and-raised part for positioning the coil holder can be used as a stopper part and thus, the part shape can be simplified.

In at least an embodiment of the present invention, the first case member is provided with a first case-third side plate part, which is extended from an end on one side in the second direction of the first end plate part to the other side in the first direction, and a first case-fourth side plate part which is extended from an end on the other side in the second direction of the first end plate part to the other side in the first direction, and the yoke is provided with a pair of connection parts, which are extended in the first direction on both sides in the second direction with respect to the coil and connect the first facing part with the second facing part, and a pair of first standing-up parts which are extended from both ends in the second direction of the first facing part to the other side in the first direction on both sides in the third direction of the pair of the connection parts, and the first case-third side plate part and the first case-fourth side plate part are disposed on both sides in the second direction with respect to the pair of the first standing-up parts to structure a second stopper part which restricts a movable range of the yoke in the second direction. According to this structure, the movable body is less likely to excessively and largely move in a vibration direction due to an impact such as falling to cause damage of the actuator. Further, the standing-up part provided for increasing a weight of the yoke can be used as a stopper and thus, the part shape can be simplified.

In at least an embodiment of the present invention, the support body includes a first plate which is made of metal and is overlapped with the coil, the first coil holding part and the second coil holding part from the one side in the first direction, and a second plate which is made of metal and is overlapped with the coil, the first coil holding part and the second coil holding part from the other side in the first direction, and the connection body includes a first connection body which connects the first facing part with the first plate and a second connection body which connects the second facing part with the second plate. According to this structure, the coil is protected by the first plate and the second plate and thus, the coil is not likely to be damaged due to a collision with the magnet. Further, the first holder member, the second holder member and the coil are held between the first plate and the second plate and thus, they can be handled as a coil assembly. Therefore, even when the coil holder is divided into two parts, the actuator can be easily assembled. Further, the coil assembly and the yoke can be connected with each other by disposing the connection body on an inner side of the yoke. Therefore, a space for disposing the connection body between the case and the yoke is not required and thus, a dimension in the first direction of the actuator can be reduced.

In at least an embodiment of the present invention, the second case member is provided with a second case-first side plate part which is extended from an end on the one side in the third direction of the second end plate part to the one side in the first direction, and a second case-second side plate part which is extended from an end on the other side in the third direction of the second end plate part to the one side in the first direction, and the first holder side plate part is provided with a first receiving part with which a tip end of the second case-first side plate part is abutted from the other side in the first direction, and the second holder side plate part is provided with a second receiving part with which a tip end of the second case-second side plate part is abutted from the other side in the first direction. According to this structure, the first case member and the second case member are abutted with the coil holder made of resin in the first direction and positioned. Therefore, positional accuracy in the first direction of the first case member and the second case member can be enhanced. Accordingly, accuracy of an outside dimension in the first direction of the case can be enhanced.

### Effects of the Invention

According to the present invention, the case of the actuator and the coil holder are positioned by sandwiching the side plate part (first holder side plate part) provided at an end in the third direction of the coil holder between the side plate part (first case-first side plate part) provided at an end in the third direction of the case and the first cut-and-raised part disposed on its inner side. Therefore, rattling in the third direction of the coil holder with respect to the case can be restrained. Further, the coil holder is positioned with the side plate part of the case as a reference and thus, positional accuracy in the third direction of the coil with respect to the case can be enhanced. In addition, the cut-and-raised part provided on an inner side of the case is used for positioning and thus, deformation of the side plate part (first case-first side plate part) of the case can be restrained when the coil holder is positioned. Therefore, lowering of accuracy of an outside dimension in the third direction of the case can be restrained.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are perspective views showing actuators which are viewed from the “Z2” direction side and the “Z1” direction side in accordance with an embodiment of the present invention.

FIG. 2 is a cross-sectional view showing an actuator which is cut in a longitudinal direction (cross-sectional view showing an actuator which is cut at the “A-A” position in FIG. 1A).

FIG. 3 is a cross-sectional view showing an actuator which is cut in a direction perpendicular to the longitudinal direction (cross-sectional view showing an actuator which is cut at the “B-B” position in FIG. 1A).

FIG. 4 is an exploded perspective view showing a state that a movable body and a coil assembly are detached from a case.

FIG. 5 is an exploded perspective view showing a movable body and a coil assembly which are viewed from the “Z2” direction side.

FIG. 6 is an exploded perspective view showing a movable body and a coil assembly which are viewed from the “Z1” direction side.

FIG. 7 is a cross-sectional view showing an actuator which is cut at positions of a first cut-and-raised part and a second cut-and-raised part (cross-sectional view showing an actuator which is cut at the “C-C” position in FIG. 1A).

FIG. 8 is an exploded perspective view showing a first case member and a coil assembly which are viewed from the “Z1” direction side.

FIG. 9 is a plan view showing an actuator in which a second case member is detached and which is viewed from the “Z2” direction side.

### DETAILED DESCRIPTION

An embodiment of an actuator to which the present invention is applied will be described below with reference to the accompanying drawings.

### (Entire Structure)

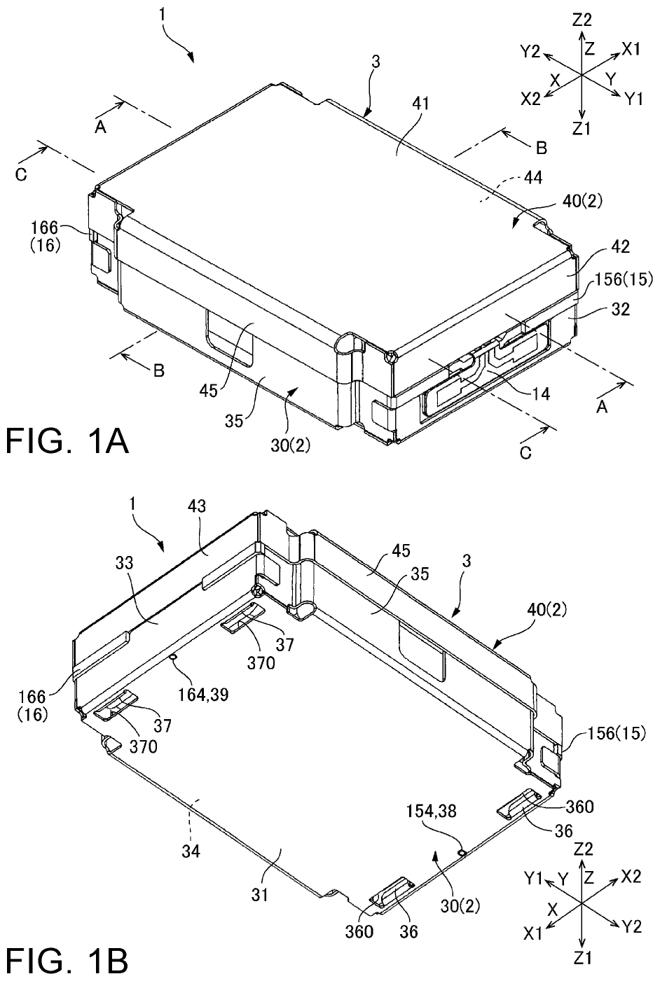

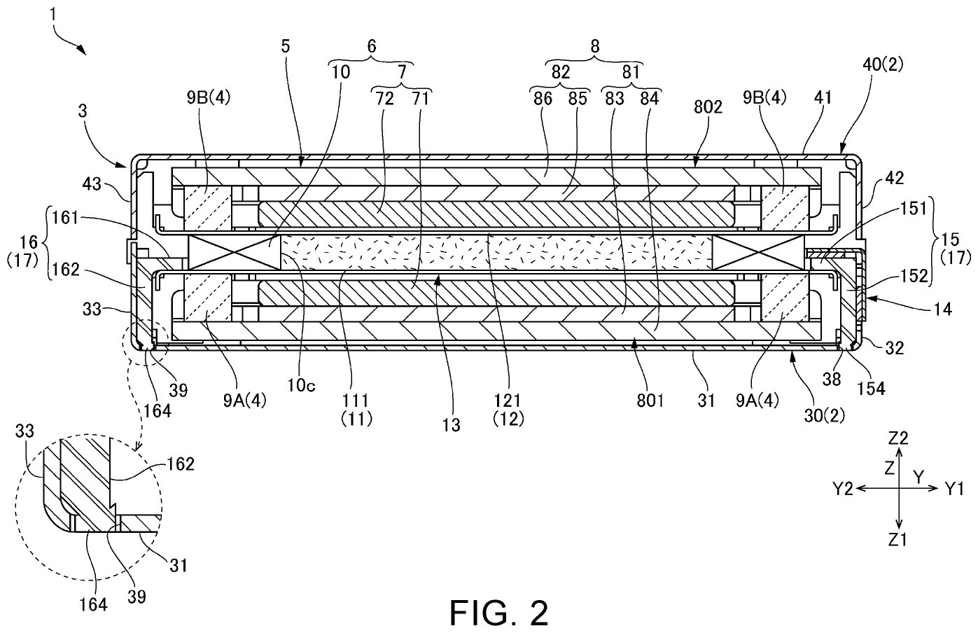

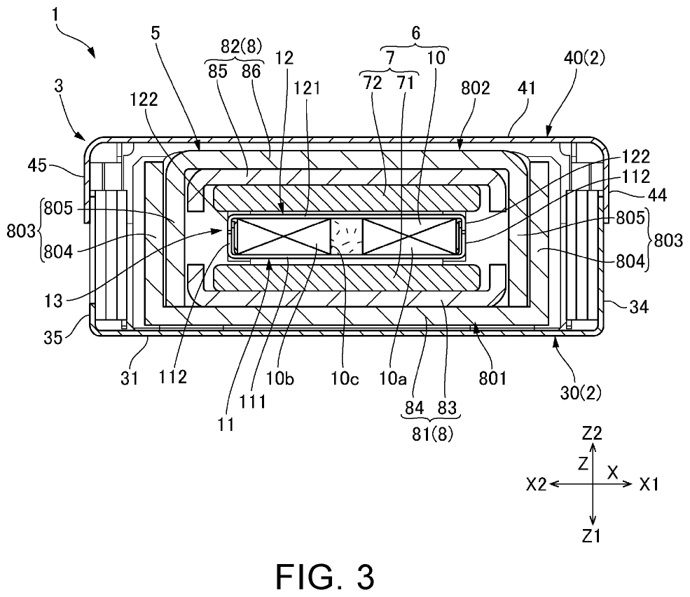

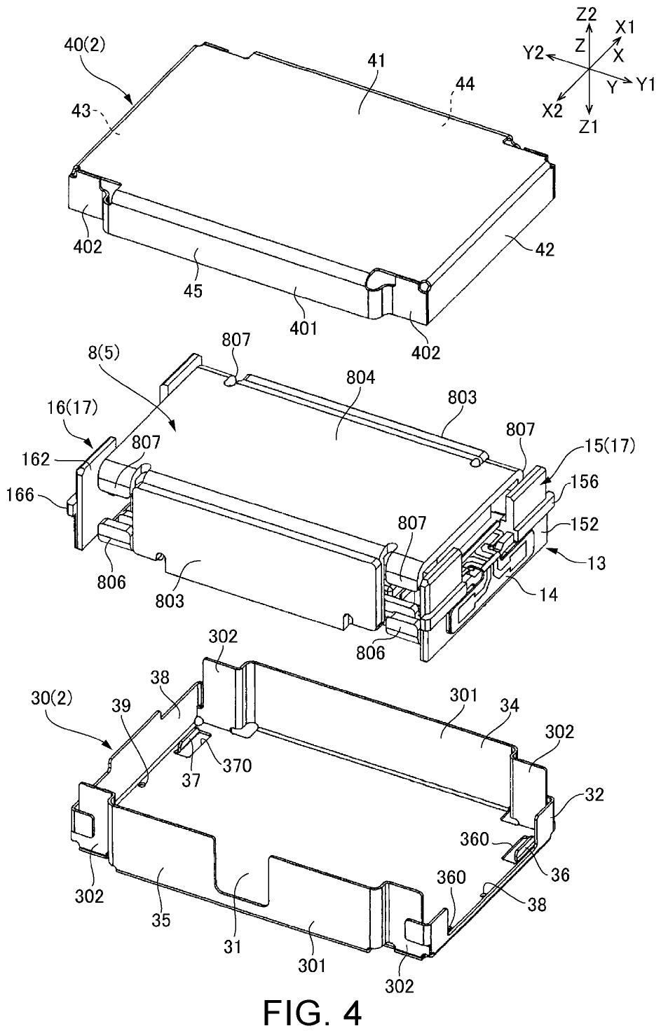

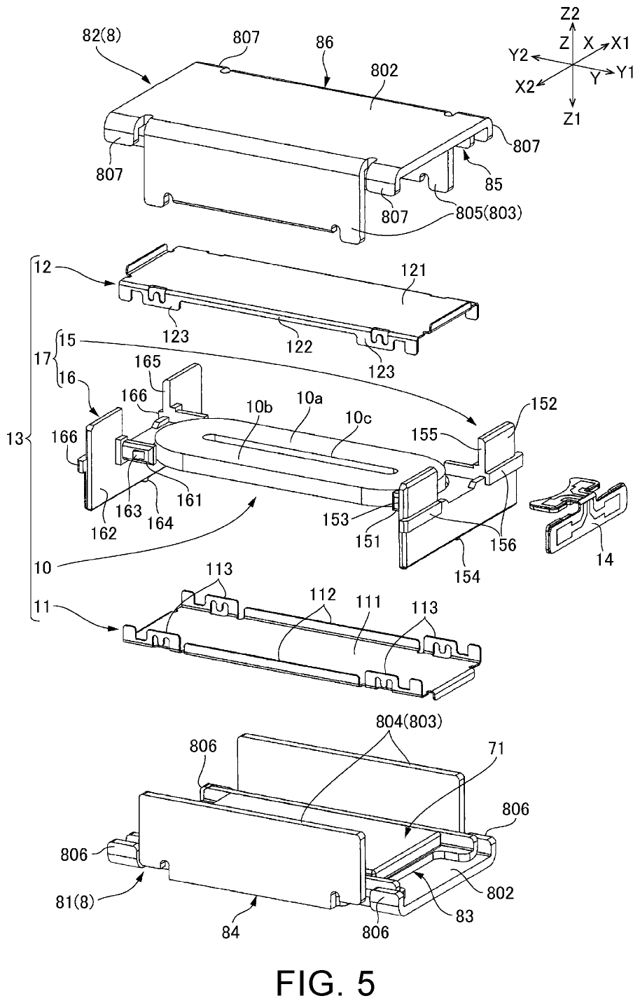

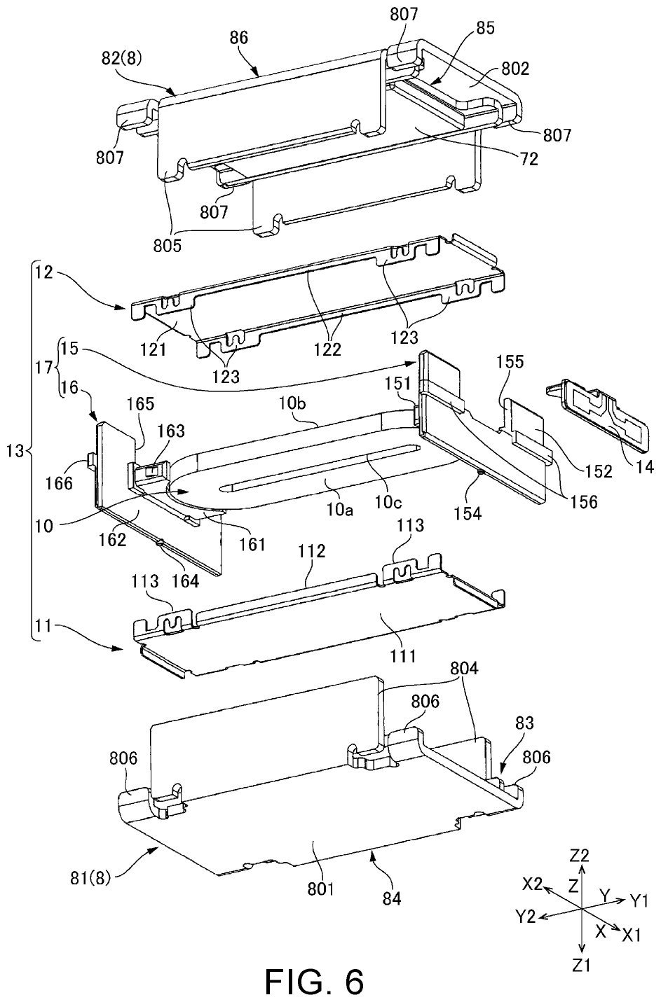

FIG. 1A is a perspective view showing an actuator 1 which is viewed from the “Z2” direction side in accordance with an embodiment of the present invention. FIG. 1B is a perspective view showing the actuator 1 which is viewed from the “Z1” direction side in accordance with an embodiment of the present invention. FIG. 2 is a cross-sectional view showing the actuator 1 which is cut in a longitudinal direction and is a cross-sectional view showing the actuator 1 which is cut at the “A-A” position in FIG. 1A. FIG. 3 is a cross-sectional view showing the actuator which is cut in a direction perpendicular to the longitudinal direction and is a cross-sectional view showing the actuator 1 which is cut at the “B-B” position in FIG. 1A. FIG. 4 is an exploded perspective view showing a state that a movable body 5 and a coil assembly 13 are detached from a case 2. FIG. 5 is an exploded perspective view showing the movable body 5 and the coil assembly 13 which are viewed from the “Z2” direction side. FIG. 6 is an exploded perspective view showing the movable body 5 and the coil assembly 13 which are viewed from the “Z1” direction side.

An actuator 1 is used as a tactile device which transmits information by vibration. As shown in FIGS. 1A and 1B, an outer shape of the actuator 1 is a rectangular parallelepiped shape. The actuator 1 generates vibration in a shorter direction of the outer shape. In the following descriptions, a shorter direction in which vibration is generated is defined as an “X” direction (second direction), a direction which is a longitudinal direction of the actuator 1 and is perpendicular to the “X” direction is defined as a “Y” direction (third direction), and a direction which is a thickness direction (height direction) of the actuator 1 and is perpendicular to the “X” direction and the “Y” direction is defined as a “Z” direction (first direction). Further, one side in the “X” direction is referred to as an “X1” direction side, and the other side is referred to as an “X2” direction side. One side in the “Y” direction is referred to as a “Y1” direction side, and the other side is referred to as a “Y2” direction side. One side in the “Z” direction is referred to as a “Z1” direction side, and the other side is referred to as a “Z2” direction side.

As shown in FIGS. 1A through 4, the actuator 1 includes a support body 3 having a case 2 which defines an outer shape of the actuator 1 and a movable body 5 which is accommodated on an inner side of the case 2. Further, the actuator 1 includes connection bodies 4 which connect the movable body 5 with the support body 3 and a magnetic drive circuit 6 (see FIGS. 2 and 3) structured to relatively move the movable body 5 in the “X” direction with respect to the support body 3.

### (Support Body)

The support body 3 includes the case 2 and a coil assembly 13. As shown in FIGS. 2, 3, 5 and 6, the coil assembly 13 includes a coil 10, a first plate 11 overlapped with the coil 10 on the “Z1” direction side, and a second plate 12 overlapped with the coil 10 on the “Z2” direction side. The first plate 11 and the second plate 12 are made of nonmagnetic metal.

As shown in FIGS. 2 and 3, the coil 10 is located at a center in the “Z” direction of the case 2. The coil 10 is an air core coil which is formed in a flat shape whose thickness direction is directed in the “Z” direction. As shown in FIGS. 5 and 6, the coil 10 is formed in an elliptical shape which is long in the “Y” direction and is provided with a pair of long side parts 10a and 10b which are extended in parallel with the “Y” direction. A center hole 10c which is extended in the “Y” direction is provided between a pair of the long side parts 10a and 10b.

As shown in FIGS. 5 and 6, the coil assembly 13 includes a first holder member 15 which is disposed on the “Y1” side of the coil 10 and a second holder member 16 which is disposed on the “Y2” side of the coil 10. The first holder member 15 and the second holder member 16 structure a coil holder 17. The first holder member 15 and the second holder member 16 are made of resin.

The first holder member 15 is provided with a first coil holding part 151 which is disposed between the first plate 11 and the second plate 12 and a first holder side plate part 152 which is extended from an end on the “Y1” side of the first coil holding part 151 to the “Z1” direction side and the “Z2” direction side. The second holder member 16 is provided with a second coil holding part 161 which is disposed between the first plate 11 and the second plate 12 and a second holder side plate part 162 which is extended from an end on the “Y2” side of the second coil holding part 161 to the “Z1” direction side and the “Z2” direction side. The coil 10 is disposed between the first coil holding part 151 and the second coil holding part 161.

The first holder member 15 is fixed with a power feeding board 14. In this embodiment, the power feeding board 14 is a flexible printed board. In accordance with an embodiment of the present invention, the power feeding board 14 may be a rigid board. Electric power is supplied to the coil 10 through the power feeding board 14.

The first plate 11 is provided with a first plate part 111 which is overlapped with the coil 10 from the “Z1” side and a pair of first bent parts 112 which are bent to the “Z2” direction side from both ends in the “X” direction of the first plate part 111. The second plate 12 is provided with a second plate part 121 which is overlapped with the coil 10 from the “Z2” side and a pair of second bent parts 122 which are bent to the “Z1” direction side from both ends in the “X” direction of the second plate part 121.

The first plate 11 is provided with first fixing parts 113, which are bent to the “Z2” direction side from the first plate part 111, on the “Y1” side and the “Y2” side with respect to each of the first bent parts 112. The second plate 11 is provided with second fixing parts 123, which are bent to the “Z1” direction side from the second plate part 121, on the “Y1” side and the “Y2” side with respect to each of the second bent parts 122.

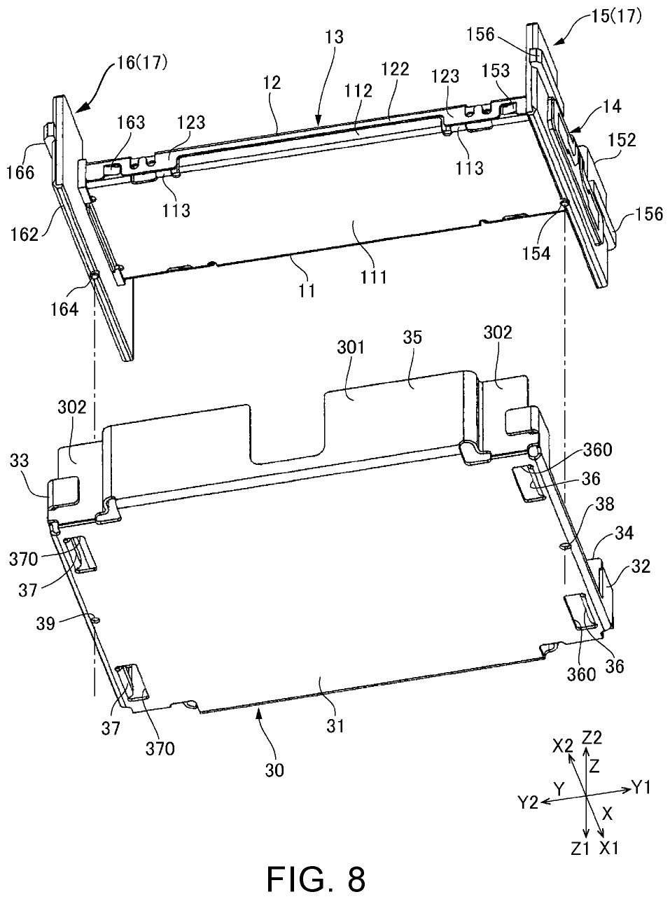

When the first plate 11 and the second plate 12 are attached to the first coil holding part 151 and the second coil holding part 161 from both sides in the “Z” direction, as shown in FIG. 3, the first bent parts 112 and the second bent parts 122 cover the long side parts 10a and 10b of the coil 10 from both sides in the “X” direction. Further, the first fixing part 113 of the first plate 11 and the second fixing part 123 of the second plate 12 are overlapped with each other on both sides in the “Y” direction with respect to the first bent part 112 and the second bent part 122. The first fixing part 113 and the second fixing part 123 are locked in the “Z” direction. Further, a claw part 153 provided on a side face of the first coil holding part 151 and a claw part 163 provided on a side face of the second coil holding part 161 are locked in cut-out parts provided in the first fixing part 113 and the second fixing part 123 which are overlapped in the “X” direction (see FIG. 8).

When the actuator 1 is to be manufactured, first, the coil assembly 13 is assembled by using the coil 10, the first plate 11, the second plate 12, the first holder member 15 and the second holder member 16. Next, the movable body 5 is assembled so as to surround the coil assembly 13, and the movable body 5 and the coil assembly 13 are connected with each other through connection bodies 4. After that, the coil assembly 13 and the movable body 5 are accommodated in the case 2. A detailed structure of the case 2 and a positioning structure of the coil assembly 13 with respect to the case 2 will be described below.

### (Movable Body)

The movable body 5 includes a magnet 7 and a yoke 8. As shown in FIGS. 2 and 3, the magnet 7 faces the coil 10 in the “Z” direction. The coil 10 and the magnet 7 structure the magnetic drive circuit 6. The movable body 5 includes a first magnet 71 and a second magnet 72 as the magnet 7. The first magnet 71 is located on the “Z1” direction side with respect to the coil 10. The second magnet 72 is located on the “Z2” direction side with respect to the coil 10. The first magnet 71 and the second magnet 72 are polarized into two portions in the “X” direction. As shown in FIG. 3, when the movable body 5 and the support body 3 are assembled, the long side parts 10a and 10b of the coil 10 face the first magnet 71 on the “Z1” direction side and face the second magnet 72 on the “Z2” direction side.

The yoke 8 is made of magnetic material. As shown in FIG. 3, the yoke 8 includes a first facing part 801 which faces the coil 10 from the “Z1” direction side and a second facing part 802 which faces the coil 10 from the “Z2” direction side. The first magnet 71 is fixed to the first facing part 801. The second magnet 72 is fixed to the second facing part 802. Further, the yoke 8 includes a pair of connection parts 803 which are extended in the “Z” direction on both sides in the “X” direction with respect to the coil 10. A pair of the connection parts 803 connects the first facing part 801 with the second facing part 802.

When the yoke 8 is to be assembled, a pair of connecting plate parts 805 extended to the “Z1” direction side from both ends in the “X” direction of the second facing part 802 is press-fitted and fixed to inner sides of a pair of connecting plate parts 804 extended to the “Z2” direction side from both ends in the “X” direction of the first facing part 801. As a result, a pair of the connection parts 803 is structured, and the yoke 8 is assembled in a shape surrounding an outer peripheral side of the coil 10, the first plate 11 and the second plate 12.

As shown in FIGS. 4 through 6, the yoke 8 includes a pair of first standing-up parts 806, which are extended to the “Z2” direction side from both ends in the “X” direction of the first facing part 801 on both sides in the “Y” direction with respect to a pair of the connection parts 803, and a pair of second standing-up parts 807 which are extended to the “Z1” direction side from both ends in the “X” direction of the second facing part 802 on both sides in the “Y” direction with respect to a pair of the connection parts 803.

As shown in FIGS. 3, 5 and 6, the yoke 8 includes a first yoke 81 and a second yoke 82. The first yoke 81 is structured of two members which are joined to each other, i.e., a first inner side member 83 overlapped with the coil 10 from the “Z1” direction side and a first outer side member 84 overlapped with the first inner side member 83 from the “Z1” direction side. The second yoke 82 is structured of two members joined to each other, i.e., a second inner side member 85 overlapped with the coil 10 from the “Z2” direction side and a second outer side member 86 overlapped with the second inner side member 85 from the “Z2” direction side.

The first facing part 801 of the yoke 8 is structured by laminating the first outer side member 84 and the first inner side member 83 in the “Z” direction. As shown in FIG. 5, a pair of the connecting plate parts 804 and the first standing-up parts 806 provided at four positions and disposed on both sides in the “Y” direction with respect to the respective connecting plate parts 804 are provided in the first outer side member 84. As shown in FIG. 2, the first facing part 801 is extended to both sides in the “Y” direction with respect to the first magnet 71 and is connected with the first plate 11 through first connection bodies 9A.

The second facing part 802 of the yoke 8 is structured by laminating the second outer side member 86 and the second inner side member 85 in the “Z” direction. As shown in FIG. 6, a pair of the connecting plate parts 805 and the second standing-up parts 807 provided at four positions and disposed on both sides in the “Y” direction with respect to the respective connecting plate parts 805 are provided in the second outer side member 86. As shown in FIG. 2, the second facing part 802 is extended to both sides in the “Y” direction with respect to the second magnet 72 and is connected with the second plate 12 through second connection bodies 9B.

### (Connection Body)

As shown in FIG. 2, the connection body 4 includes a first connection body 9A and a second connection body 9B. The first connection body 9A and the second connection body 9B are formed in a cuboid shape which is long in the “X” direction. The first connection body 9A is located on the “Z1” side with respect to the coil 10. The second connection body 9B is located on the “Z2” side with respect to the coil 10. The first connection body 9A is disposed at two positions on the “Y1” side and the “Y2” side with respect to the first magnet 71 and is structured of two members having the same shape. The second connection body 9B is disposed at two positions on the “Y1” side and the “Y2” side with respect to the second magnet 72 and is structured of two members having the same shape. Each of the first connection body 9A and the second connection body 9B is provided with at least one of elasticity and viscoelasticity.

The first connection body 9A is, as described above, sandwiched between the first facing part 801 of the yoke 8 and the first plate 11 on both sides in the “Y” direction of the coil 10. The first connection body 9A is compressed in the “Z” direction between the first facing part 801 and the first plate 11. The second connection body 9B is, as described above, sandwiched between the second facing part 802 of the yoke 8 and the second plate 12 on both sides in the “Y” direction of the coil 10. The second connection body 9B is compressed in the “Z” direction between the second facing part 802 and the second plate 12.

In this embodiment, the first connection body 9A and the second connection body 9B are gel state members made of silicone gel. Silicone gel is a viscoelastic body whose spring constant when it deforms in an expansion and contraction direction is about three times of a spring constant when it deforms in a shearing direction. A viscoelastic body deforms in a pulled and extended direction when it is deformed in a direction intersecting a thickness direction (in a shearing direction) and thus, the viscoelastic body has a deformation characteristic that a linear component is larger than a non-linear component. Further, a viscoelastic body has a deformation characteristic that a non-linear component is larger than a linear component when it is pressed to be compressed and deformed in a thickness direction and, on the other hand, when a viscoelastic body is pulled and extended in the thickness direction, it has a deformation characteristic that a linear component is larger than a non-linear component.

In accordance with an embodiment of the present invention, as the first connection body 9A and the second connection body 9B, the following material may be used; in other words, various rubber materials such as natural rubber, diene-based rubber (for example, styrene butadiene rubber, isoprene rubber, butadiene rubber, chloroprene rubber and acrylonitrile butadiene rubber), non-diene-based rubber (for example, butyl rubber, ethylene propylene rubber, ethylene propylene diene rubber, urethane rubber, silicone rubber and fluorine-containing rubber) and thermoplastic elastomer, and their denatured materials.

### (Case)

As shown in FIGS. 1 through 4, the case 2 includes a first case member 30 and a second case member 40 which are overlapped in the “Z” direction. The first case member 30 is assembled to the coil assembly 13 from the “Z1” direction side. The second case member 40 is assembled to the coil assembly 13 and the first case member 30 from the “Z2” direction side.

The first case member 30 is provided with a first end plate part 31 in a substantially rectangular shape which faces the coil 10 from the “Z1” direction side. Further, the first case member 30 is provided with a first case-first side plate part 32 which is extended from an end on the “Y1” direction side of the first end plate part 31 to the “Z2” direction side, a first case-second side plate part 33 which is extended from an end on the “Y2” direction side of the first end plate part 31 to the “Z2” direction side, a first case-third side plate part 34 which is extended from an end on the “X1” direction side of the first end plate part 31 to the “Z2” direction side, and a first case-fourth side plate part 35 which is extended from an end on the “X2” direction side of the first end plate part 31 to the “Z2” direction side.

The first end plate part 31 is provided with protruded portions which are protruded to both sides in the “X” direction in a center portion in the “Y” direction. Therefore, each of the first case-third side plate part 34 and the first case-fourth side plate part 35 is provided with a side plate center part 301, which is extended from a tip end of the protruded portion of the first end plate part 31 to the “Z2” direction side, and side plate end portions 302 which are provided at positions shifted to a center side in the “X” direction with respect to the side plate center part 301 on both sides in the “Y” direction of the side plate center part 301. Both ends in the “Y” direction of the side plate center part 301 are connected with stepped parts which are bent at a substantially right angle toward a center in the “X” direction of the first case member 30, and the side plate center part 301 and the side plate end portion 302 are connected with each other through the stepped part.

The second case member 40 is provided with a second end plate part 41 in a substantially rectangular shape which faces the coil 10 from the “Z2” direction side. Further, the second case member 40 is provided with a second case-first side plate part 42 which is extended from an end on the “Y1” direction side of the second end plate part 41 to the “Z1” direction side, a second case-second side plate part 43 which is extended from an end on the “Y2” direction side of the second end plate part 41 to the “Z1” direction side, a second case-third side plate part 44 which is extended from an end on the “X1” direction side of the second end plate part 41 to the “Z1” direction side, and a second case-fourth side plate part 45 which is extended from an end on the “X2” direction side of the second end plate part 41 to the “Z1” direction side.

The second end plate part 41 is provided with protruded portions which are protruded to both sides in the “X” direction in a center portion in the “Y” direction. Therefore, each of the second case-third side plate part 44 and the second case-fourth side plate part 45 is provided with a side plate center part 401, which is extended from a tip end of the protruded portion of the second end plate part 41 to the “Z1” direction side, and side plate end portions 402 which are provided at positions shifted to a center side in the “X” direction with respect to the side plate center part 401 on both sides in the “Y” direction of the side plate center part 401. Both ends in the “Y” direction of the side plate center part 401 are connected with stepped parts which are bent at a substantially right angle toward a center in the “X” direction of the second case member 40, and the side plate center part 401 and the side plate end portion 402 are connected with each other through the stepped part.

### (Positioning Structure of Case and Coil Holder)

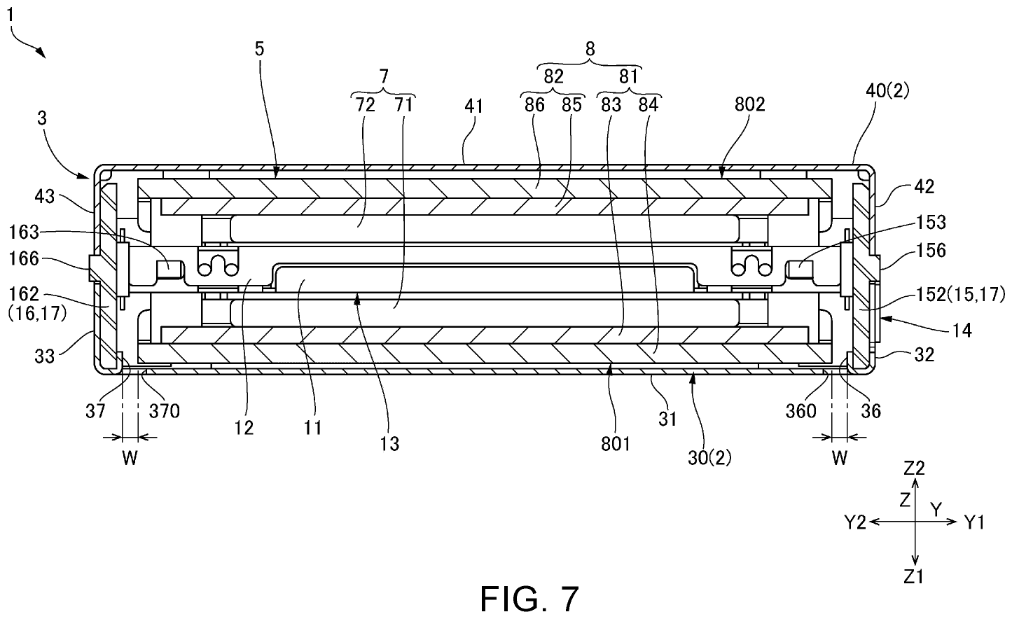

FIG. 7 is a cross-sectional view showing the actuator 1 which is cut at positions of a first cut-and-raised part 36 and a second cut-and-raised part 37 (cross-sectional view showing the actuator 1 which is cut at the “C-C” position in FIG. 1A). FIG. 8 is an exploded perspective view showing the first case member 30 and the coil assembly 13 which are viewed from the “Z1” direction side. As shown in FIGS. 1B and 4, the first case member 30 is provided with a first cut-and-raised part 36, which is disposed at two positions on an inner side (“Y2” side) with respect to the first case-first side plate part 32, and a second cut-and-raised part 37 which is disposed at two positions on an inner side (“Y1” side) with respect to the first case-second side plate part 33. The first cut-and-raised part 36 is extended to the “Z2” direction side from an edge on the “Y1” side of each of two opening parts 360 which are provided at both ends in the “X” direction in an end part on the “Y1” side of the first end plate part 31. The second cut-and-raised part 37 is extended to the “Z2” direction side from an edge on the “Y2” side of each of two opening parts 370 which are provided at both ends in the “X” direction in an end part on the “Y2” side of the first end plate part 31.

As shown in FIG. 7, an end part on the “Z1” direction side of the first holder side plate part 152 is sandwiched between the first case-first side plate part 32 and the first cut-and-raised part 36 and thereby. the first holder member 15 is positioned in the “Y” direction with respect to the first case member 30. Further, a tip end on the “Z1” direction side of the first holder side plate part 152 is abutted with the first end plate part 31 from the “Z2” direction side and thereby, the first holder member 15 is positioned in the “Z” direction with respect to the first case member 30.

As shown in FIG. 8, the first holder member 15 is provided with a first positioning protruded part 154 which is protruded from a tip end face on the “Z1” direction side of the first holder side plate part 152 to the “Z1” direction side. An end part on the “Y1” side of the first end plate part 31 is provided with a first positioning hole 38 which penetrates through a middle position between the two opening parts 360. When a tip end on the “Z1” direction side of the first holder side plate part 152 is inserted between the first case-first side plate part 32 and the first cut-and-raised part 36, as shown in FIG. 2, the first holder member 15 is positioned so that the first positioning protruded part 154 is fitted to the first positioning hole 38. As a result, the first holder member 15 is positioned in the “X” direction with respect to the first case member 30.

Similarly, an end part on the “Z1” direction side of the second holder side plate part 162 is sandwiched between the first case-second side plate part 33 and the second cut-and-raised part 37 and thereby, the second holder member 16 is positioned in the “Y” direction with respect to the first case member 30. Further, a tip end on the “Z1” direction side of the second holder side plate part 162 is abutted with the first end plate part 31 from the “Z2” direction side and thereby, the second holder member 16 is positioned in the “Z” direction with respect to the first case member 30.

As shown in FIG. 8, the second holder member 16 is provided with a second positioning protruded part 164 which is protruded from a tip end face on the “Z1” direction side of the second holder side plate part 162 to the “Z1” direction side. An end part on the “Y2” side of the first end plate part 31 is provided with a second positioning hole 39 which penetrates through a middle position between the two opening parts 370. When a tip end on the “Z1” direction side of the second holder side plate part 162 is inserted between the first case-second side plate part 33 and the second cut-and-raised part 37, as shown in FIG. 2, the second holder member 16 is positioned so that the second positioning protruded part 164 is fitted to the second positioning hole 39. As a result, the second holder member 16 is positioned in the “X” direction with respect to the first case member 30.

When the coil assembly 13 and the movable body 5 are accommodated in the case 2, the first holder member 15 is positioned in the first case member 30 and the second holder member 16 is positioned in the first case member 30 by the above-mentioned positioning structure. As a result, two parts structuring the coil holder 17 are positioned with the first case member 30 as a reference.

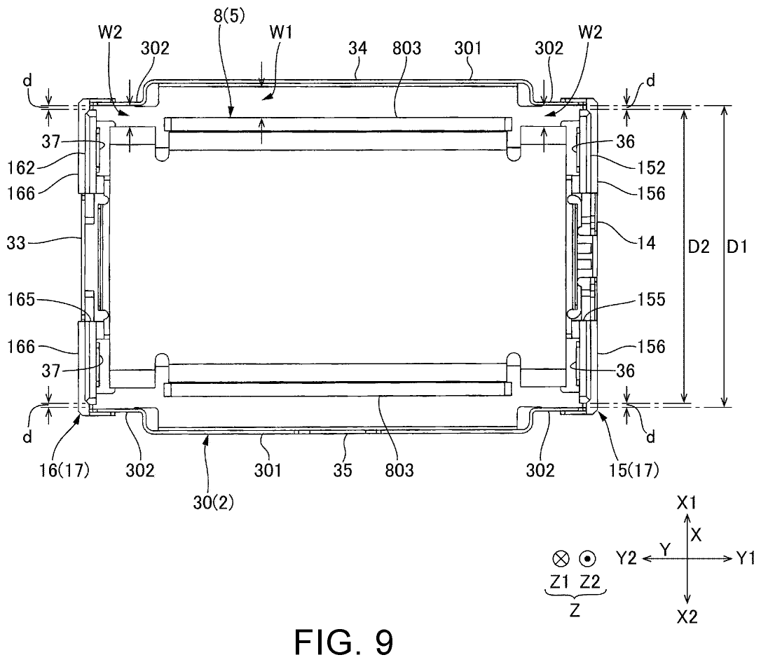

FIG. 9 is a plan view showing the actuator 1 in which the second case member 40 is detached and which is viewed from the “Z2” direction side. As shown in FIG. 9, in an end part on the “Y1” direction side of the first case member 30, a distance “D1” in the “X” direction between the first case-third side plate part 34 and the first case-fourth side plate part 35 which define an outside dimension in the “X” direction of the first case member 30 is larger than a width “D2” in the “X” direction of the first holder side plate part 152. In this embodiment, when the first holder side plate part 152 is positioned at a center in the “X” direction of the first end plate part 31 by fitting the first positioning protruded part 154 to the first positioning hole 38, predetermined gap spaces “d” are respectively formed between the first holder side plate part 152 and the first case-third side plate part 34 and between the first holder side plate part 152 and the first case-fourth side plate part 35. Similarly, in an end part in the “Y2” direction side of the first case member 30, predetermined gap spaces “d” are respectively formed between the second holder side plate part 162 and the first case-third side plate part 34 and between the second holder side plate part 162 and the first case-fourth side plate part 35.

As described above, in this embodiment, the first holder side plate part 152 and the second holder side plate part 162 are not press-fitted between the first case-third side plate part 34 and the first case-fourth side plate part 35. Therefore, an outer shape in the “X” direction of the first case member 30 is prevented from being deformed at a time of assembling of the first holder member 15 and the second holder member 16. Further, both of the first holder side plate part 152 and the second holder side plate part 162 are positioned with a high degree of accuracy by using the cut-and-raised parts provided on an inner side of the first case member 30 with the side plate part in the “Y” direction of the first case member 30 (first case-first side plate part 32 and first case-second side plate part 33) as a reference. Further, in this case, there is a little possibility that the side plate parts in the “Y” direction of the first case member 30 (first case-first side plate part 32 and first case-second side plate part 33) are deformed and thus, an outer shape in the “Y” direction of the first case member 30 is restrained from being deformed at a time of assembling of the first holder member 15 and the second holder member 16.

### (Positioning Structure of Second Case Member)

After the coil assembly 13 and the movable body 5 have been assembled into the first case member 30, when the first case member 30, the coil assembly 13 and the movable body 5 are covered with the second case member 40 from the “Z2” direction side, as shown in FIGS. 2 and 7, the tip ends on the “Z2” direction side of the first holder side plate part 152 and the second holder side plate part 162 are inserted on an inner side of the side plate parts in the “Y” direction of the second case member 40 (second case-first side plate part 42 and second case-second side plate part 43). Therefore, the second case member 40 is positioned in the “Y” direction through the first holder member 15 and the second holder member 16.

Further, in this case, as shown in FIG. 3, the side plate parts in the “X” direction of the second case member 40 (second case-third side plate part 44 and second case-fourth side plate part 45) are fitted on an outer side of the side plate parts in the “X” direction of the first case member 30 (first case-third side plate part 34 and first case-fourth side plate part 35). As a result, the second case member 40 is positioned in the “X” direction with respect to the first case member 30.

As shown in FIG. 4, heights in the “Z” direction of the side plate parts in the “Y” direction of the first case member 30 (first case-first side plate part 32 and first case-second side plate part 33) are lower than the side plate parts in the “X” direction (first case-third side plate part 34 and first case-fourth side plate part 35). As shown in FIG. 7, the first holder side plate part 152 is provided with first receiving parts 156 which are protruded from its face on the “Y1” side to the “Y1” direction side. However, a tip end of the first case-first side plate part 32 is located on the “Z1” side with respect to the first receiving parts 156 and thus, the first case-first side plate part 32 does not interfere with the first receiving parts 156. Similarly, the second holder side plate part 162 is provided with second receiving parts 166 which are protruded from its face on the “Y2” side to the “Y2” direction side. However, a tip end of the first case-second side plate part 33 is located on the “Z1” side with respect to the second receiving parts 166 and thus, the first case-second side plate part 33 does not interfere with the second receiving parts 166.

As shown in FIGS. 5 and 6, the first holder member 15 is provided with a first recessed part 155 having a shape which is formed by cutting out a center portion in the “X” direction of the first holder side plate part 152 to the “Z1” direction side. One end of the power feeding board 14 is extended from the first recessed part 155 to the “Y1” side with respect to the first holder side plate part 152 and is bent to the “Z1” side. The first receiving parts 156 are extended in a straight-line shape in the “X” direction on both sides in the “X” direction with respect to the first recessed part 155. Similarly, the second holder member 16 is provided with a second recessed part 165 having a shape which is formed by cutting out a center portion in the “X” direction of the second holder side plate part 162 to the “Z1” direction side. The second receiving parts 166 are extended in a straight-line shape in the “X” direction on both sides in the “X” direction with respect to the second recessed part 165.

When the first case member 30, the coil assembly 13 and the movable body 5 are covered with the second case member 40 from the “Z2” direction side, as shown in FIG. 7, the side plate parts in the “Y” direction of the second case member 40 (second case-first side plate part 42 and second case-second side plate part 43) are respectively abutted with the first receiving parts 156 and the second receiving parts 166 from the “Z2” direction side. As a result, the second case member 40 is positioned in the “Z” direction with respect to the first case member 30 through the first holder member 15 and the second holder member 16 which are made of resin.

### (First Stopper Part)

When the first case member 30, the coil assembly 13 and the movable body 5 are assembled, as shown in FIG. 7, the first cut-and-raised part 36 faces the first facing part 801 of the yoke 8 from the “Y1” side, and the second cut-and-raised part 37 faces the first facing part 801 from the “Y2” side. In this case, predetermined spaces “W” are respectively formed between an end face on the “Y1” side of the first facing part 801 and the first cut-and-raised part 36 and between an end face on the “Y2” side of the first facing part 801 and the second cut-and-raised part 37. Therefore, the first cut-and-raised part 36 and the second cut-and-raised part 37 function as a first stopper part which restricts a movable range in the “Y” direction of the movable body 5.

### (Second Stopper Part)

As shown in FIG. 9, the first case-third side plate part 34 faces the yoke 8 from the “X1” side and the first case-fourth side plate part 35 faces the yoke 8 from the “X2” side. More specifically, a pair of the connection parts 803 which are disposed in side faces in the “X” direction in a center portion in the “Y” direction of the yoke 8 faces the side plate center parts 301 from the “X2” direction side and the “X1” direction side. Further, the first standing-up part 806 and the second standing-up part 807 which are disposed in the side faces in the “X” direction in an end part on the “Y1” direction side of the yoke 8 respectively face the side plate end portions 302 from the “X2” direction side and the “X1” direction side. In this embodiment, spaces “W2” in the “X” direction between the first standing-up part 806 and the second standing-up part 807 and the side plate end portion 302 are narrower than spaces “W1” in the “X” direction between the connection part 803 and the side plate center part 301. Therefore, the side plate end portions 302 function as a second stopper part which restricts a movable range in the “X” direction of the movable body 5 in an inside of the case 2.

(Principal Operations and Effects in this Embodiment)

As described above, the actuator 1 in this embodiment includes the movable body 5, the support body 3 having the case 2 which is made of metal and accommodates the movable body 5 and the coil holder 17 made of resin, and the connection body 4 which is connected with the movable body 5 and the support body 3. Further, the actuator 1 includes the magnetic drive circuit 6 which includes the coil 10 held by the coil holder 17 and the magnet 7 facing the coil 10 in the “Z” direction and is structured so that the movable body 5 is vibrated in the “X” direction intersecting the “Z” direction with respect to the support body 3. The coil holder 17 is structured of two parts, i.e., the first holder member 15 and the second holder member 16, and the first holder member 15 is provided with the first holder side plate part 152 which is extended in the “Z” direction on the “Y1” direction side with respect to the coil 10. The case 2 includes the first case member 30 provided with the first end plate part 31, which faces the movable body 5 from the “Z1” direction side, and the second case member 40 provided with the second end plate part 41 which faces the movable body 5 from the “Z2” direction side. The first case member 30 is provided with the first case-first side plate part 32 extended from an end on the “Y1” direction side of the first end plate part 31 to the “Z2” direction side and the first cut-and-raised part 36 which is cut and raised from the first end plate part 31 to the “Z2” direction side on the “Y2” direction side with respect to the first case-first side plate part 32. The end part on the “Z1” direction side of the first holder side plate part 152 is sandwiched between the first case-first side plate part 32 and the first cut-and-raised part 36.

As described above, in this embodiment, the case 2 and the first holder member 15 are positioned each other by sandwiching the side plate part (first holder side plate part 152) provided at an end in the “Y” direction of the first holder member 15 between the side plate part (first case-first side plate part 32) provided at an end on the “Y1” direction side of the case 2 and the first cut-and-raised part 36 disposed on its inner side. Therefore, rattling in the “Y” direction of the first holder member 15 with respect to the case 2 can be restrained. Further, the first holder member 15 is positioned with the side plate part of the case 2 as a reference and thus, positional accuracy in the “Y” direction of the coil 10 with respect to the case 2 can be enhanced through the first holder member 15. In addition, the first cut-and-raised part 36 provided on an inner side of the case 2 is used for positioning and thus, deformation of the side plate part (first case-first side plate part 32) of the case 2 can be restrained when the first holder member 15 is positioned. Therefore, lowering of accuracy of an outside dimension in the “Y” direction of the case 2 can be restrained.

In this embodiment, the first holder side plate part 152 is provided with the first positioning protruded part 154 protruded in the “Z” direction, and the first end plate part 31 is provided with the first positioning hole 38 to which the first positioning protruded part 154 is fitted. As described above, the protrusion and the hole are fitted to each other in the “Z” direction and thus, rattling in the “X” direction of the first holder member 15 with respect to the case 2 can be restrained, and positional accuracy in the “X” direction of the first holder member 15 can be enhanced with respect to the case 2. Further, a space in the “X” direction can be provided between the first holder side plate part 152 and the case 2 and thus, lowering of accuracy of an outside dimension in the “X” direction of the case 2 can be restrained.

In this embodiment, in addition to the positioning structure between the case 2 and the first holder member 15, the positioning structure is also provided between the case 2 and the second holder member 16. In other words, the first case member 30 is provided with the first case-second side plate part 33, which is extended from an end on the “Y2” direction side of the first end plate part 31 to the “Z2” direction side, and the second cut-and-raised part 37 which is cut and raised to the “Z2” direction side from the first end plate part 31 on the “Y1” direction side with respect to the first case-second side plate part 33 and, in addition, an end part on the “Z1” direction side of the second holder side plate part 162 is sandwiched between the first case-second side plate part 33 and the second cut-and-raised part 37.

As described above, in this embodiment, each of the first holder side plate part 152 and the second holder side plate part 162 is sandwiched and positioned between the side plate part of the case 2 and the cut-and-raised part provided on its inner side at both ends in the “Y” direction of the case 2. Therefore, even when the coil holder 17 is divided into two parts, rattling in the “Y” direction of the coil holder 17 with respect to the case 2 can be restrained, and positional accuracy in the “Y” direction of the coil 10 can be enhanced with respect to the case 2. Further, lowering of accuracy of an outside dimension in the “Y” direction of the case 2 can be restrained.

Further, since the coil holder 17 is divided into two parts in the “Y” direction, portions covering both sides in the “X” direction of the coil 10 are not required and thus, an outside dimension in the “X” direction of the actuator 1 can be reduced. Alternatively, a size of the coil 10 can be increased without increasing an outer shape of the actuator 1 and thus, thrust of the magnetic drive circuit 6 is increased and large vibration can be generated.

In this embodiment, the second holder side plate part 162 is provided with the second positioning protruded part 164 protruded in the “Z” direction, and the first end plate part 31 is provided with the second positioning hole 39 to which the second positioning protruded part 164 is fitted. As a result, rattling in the “X” direction of the second holder member 16 with respect to the case 2 can be restrained, and positional accuracy in the “X” direction of the second holder member 16 can be enhanced with respect to the case 2. Further, lowering of accuracy of an outside dimension in the “X” direction of the case 2 can be restrained.

In this embodiment, the first case member 30 is provided with the first cut-and-raised part 36 and the second cut-and-raised part 37 and thus, the opening parts 360 and 370 are formed in the first end plate part 31. When the first holder side plate member 152 and the second holder side plate part 162 are to be assembled into the first case member 30, the movable body 5 assembled in a shape so as to surround the periphery of the coil assembly 13 is simultaneously accommodated in the first case member 30. In this case, the movable body 5 can be positioned by inserting a jig to an inner side of the first case member 30 through the opening parts 360 and 370. Therefore, when the opening parts 360 and 370 are utilized as working holes, the actuator 1 can be easily assembled.

In this embodiment, the movable body 5 includes the yoke 8 which holds the magnet 7. The yoke 8 includes the first facing part 801 which faces the coil 10 from the “Z1” direction side and the second facing part 802 which faces the coil 10 from the “Z2” direction side. The first facing part 801 is fixed with the first magnet 71, and the second facing part 802 is fixed with the second magnet 72. The first cut-and-raised part 36 and the second cut-and-raised part 37 face the first facing part 801 from both sides in the “Y” direction and function as the first stopper part which restricts a movable range in the “Y” direction of the yoke 8. Therefore, when the movable body 5 is going to move largely in the “Y” direction which is different from a vibration direction due to an impact such as falling, the movement is restricted and thus, the movable body 5 is less likely to be excessively and largely moved in the “Y” direction to cause damage of the actuator 1. Further, the cut-and-raised part for positioning the coil holder 17 can be used as a stopper part in the “Y” direction and thus, a part shape can be simplified.

In this embodiment, the first case member 30 is provided with the first case-third side plate part 34, which is extended from an end on the “X1” direction side of the first end plate part 31 to the “Z2” direction side, and the first case-fourth side plate part 35 which is extended from an end on the “X2” direction side of the first end plate part 31 to the “Z2” direction side. The yoke 8 is provided with a pair of the connection parts 803, which are extended in the “Z” direction on both sides in the “X” direction with respect to the coil 10 and connect the first facing part 801 with the second facing part 802, and a pair of the first standing-up parts 806 which are extended from both ends in the “X” direction of the first facing part 801 to the “Z2” direction side on both sides in the “Y” direction with respect to a pair of the connection parts 803. The first case-third side plate part 34 and the first case-fourth side plate part 35 are provided with the side plate end portions 302 which are disposed on both sides in the “X” direction with respect to a pair of the first standing-up parts 806. The side plate end portions 302 function as the second stopper part which restricts a movable range in the “X” direction of the yoke 8. Therefore, the movable body 5 is less likely to excessively and largely move in a vibration direction (“X” direction) due to an impact such as falling to damage the actuator 1. Further, the first standing-up parts 806 provided for increasing weight of the yoke 8 can be used as a stopper and thus, a part shape can be simplified.

In this case, even in a case that the first standing-up parts 806 are not formed, both ends in the “X” direction of the first facing part 801 face the side plate end portions 302 and thus, the side plate end portions 302 are capable of functioning as the second stopper part.

In this embodiment, the second case member 40 is provided with the second case-first side plate part 42, which is extended from an end on the “Y1” direction side of the second end plate part 41 to the “Z1” direction side, and the second case-second side plate part 43 which is extended from an end on the “Y2” direction side of the second end plate part 41 to the “Z1” direction side. The first holder side plate part 152 is provided with the first receiving parts 156 with which a tip end of the second case-first side plate part 42 is abutted from the “Z2” direction side. The second holder side plate part 162 is provided with the second receiving parts 166 with which a tip end of the second case-second side plate part 43 is abutted from the “Z2” direction side. As described above, in this embodiment, the first case member 30 and the second case member 40 are abutted with the coil holder 17 made of resin in the “Z” direction and are positioned and thus, positional accuracy in the “Z” direction of the first case member 30 and the second case member 40 can be enhanced. Therefore, accuracy of an outside dimension in the “Z” direction of the case 2 can be enhanced.

In this embodiment, the support body 3 includes the first plate 11 made of metal, which is overlapped with the coil 10, the first coil holding part 151 and the second coil holding part 161 from the “Z1” direction side, and the second plate 12 made of metal which is overlapped with the coil 10, the first coil holding part 151 and the second coil holding part 161 from the “Z2” direction side. According to this structure, the coil 10 is protected by the first plate 11 and the second plate 12 and thus, the coil 10 is not likely to be damaged due to a collision with the magnet 7. Further, the first holder member 15, the second holder member 16 and the coil 10 are held between the first plate 11 and the second plate 12 and thus, they can be handled as the coil assembly 13. Therefore, even when the coil holder 17 is divided into two parts, the actuator 1 can be easily assembled.

In this embodiment, the connection body 4 includes the first connection body 9A connecting the first facing part 801 with the first plate 11 and the second connection body 9B connecting the second facing part 802 with the second plate 12. As described above, when the connection body 4 is disposed on an inner side of the yoke 8 and connects the coil assembly 13 with the yoke 8, a space for disposing the connection body 4 is not required between the case 2 and the yoke 8 and thus, a dimension in the “Z” direction of the actuator 1 can be reduced.

### Modified Embodiments

(1) In the embodiment described above, the first holder side plate part 152 and the second holder member 16 are provided with positioning protruded parts, and the first end plate part 31 is provided with positioning hole. However, arrangement of the positioning protrusions and the holes may be reversed. In other words, it may be structured that one of the first holder side plate part 152 and the first end plate part 31 is provided with a first positioning protruded part which is protruded in the “Z” direction, and the other of the first holder side plate part 152 and the first end plate part 31 is provided with a first positioning hole to which the first positioning protruded part is fitted. Further, it may be structured that one of the second holder side plate part 162 and the first end plate part 31 is provided with a second positioning protruded part protruded in the “Z” direction, and the other of the second holder side plate part 162 and the first end plate part 31 is provided with a second positioning hole to which the second positioning protruded part is fitted.
(2) In the embodiment described above, the coil holder 17 is divided into two parts in the “Y” direction and is structured of two members. However, the coil holder 17 may be structured of one member. For example, the coil holder 17 may be structured so that its plate part connecting the first holder side plate part 152 with the second holder side plate part 162 is provided with a coil arrangement hole. In this case, it may be structured that one or both of the first holder side plate part 152 and the second holder side plate part 162 are positioned by being sandwiched between a cut-and-raised part which is formed in the first end plate part 31 and a side plate part in the “Y” direction of the first case member 30.
(3) In the embodiment described above, the first magnet 71 and the second magnet 72 are provided as the magnet 7. However, only one of the first magnet 71 and the second magnet 72 may be provided as the magnet 7.
(4) In the embodiment described above, the first connection body 9A and the second connection body 9B are provided as the connection body 4. However, only one of the first connection body 9A and the second connection body 9B may be provided as the connection body 4.
(5) In the embodiment described above, the yoke 8 is structured so that each of the first yoke 81 and the second yoke 82 is structured of an inner side member and an outer side member which are laminated each other. However, each of the first yoke 81 and the second yoke 82 may be structured of only an outer side member.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator comprising:
a movable body;
a support body comprising a case which is made of metal and accommodates the movable body, and a coil holder made of resin;
a connection body which is connected with the movable body and the support body; and
a magnetic drive circuit comprising a coil which is held by the coil holder and a magnet which faces the coil in a first direction, the magnetic drive circuit being structured to vibrate the movable body with respect to the support body in a second direction intersecting the first direction;
wherein according to a direction intersecting the first direction and intersecting the second direction being referred to as a third direction,
the coil holder comprises a first holder side plate part which is extended in the first direction on one side in the third direction with respect to the coil;
the case comprises:
a first case member comprising a first end plate part which faces the movable body from one side in the first direction; and
a second case member comprising a second end plate part which faces the movable body from an other side in the first direction;
the first case member comprises:
a first case-first side plate part which is extended from an end on one side in the third direction of the first end plate part to the other side in the first direction; and
a first cut-and-raised part which is cut and raised to the other side in the first direction from the first end plate part on an other side in the third direction with respect to the first case-first side plate part; and
an end part on the one side in the first direction of the first holder side plate part is sandwiched between the first case-first side plate part and the first cut-and-raised part.

2. The actuator according to claim 1, wherein
one of the first holder side plate part and the first end plate part comprises a first positioning protruded part which is protruded in the first direction, and
an other of the first holder side plate part and the first end plate part comprises a first positioning hole to which the first positioning protruded part is fitted.

3. The actuator according to claim 1, wherein
the coil holder comprises:
a first holder member comprising:
a first coil holding part which is disposed on one side in the third direction with respect to the coil; and
the first holder side plate part which is extended in the first direction from an end on the one side in the third direction of the first coil holding part, and
a second holder member comprising:
a second coil holding part which is disposed on the other side in the third direction with respect to the coil; and
a second holder side plate part which is extended in the first direction from an end on the other side in the third direction of the second coil holding part,
the first case member comprises:
a first case-second side plate part which is extended to the other side in the first direction from an end on the other side in the third direction of the first end plate part; and
a second cut-and-raised part which is cut and raised from the first end plate part to the other side in the first direction on the one side in the third direction with respect to the first case-second side plate part, and
an end part on the one side in the first direction of the second holder side plate part is sandwiched between the first case-second side plate part and the second cut-and-raised part.

4. The actuator according to claim 3, wherein
one of the second holder side plate part and the first end plate part comprises a second positioning protruded part which is protruded in the first direction, and
an other of the second holder side plate part and the first end plate part comprises a second positioning hole to which the second positioning protruded part is fitted.

5. The actuator according to claim 3, wherein
the movable body comprises a yoke which holds the magnet,
the yoke comprises a first facing part facing the coil from the one side in the first direction and a second facing part facing the coil from the other side in the first direction,
the magnet is fixed to at least one of the first facing part and the second facing part, and
the first cut-and-raised part and the second cut-and-raised part face the first facing part from both sides in the third direction to structure a first stopper part which restricts a movable range of the yoke in the third direction.

6. The actuator according to claim 5, wherein
the first case member comprises:
a first case-third side plate part which is extended from an end on one side in the second direction of the first end plate part to the other side in the first direction; and
a first case-fourth side plate part which is extended from an end on an other side in the second direction of the first end plate part to the other side in the first direction,
the yoke comprises:
a pair of connection parts which are extended in the first direction on both sides in the second direction with respect to the coil and connect the first facing part with the second facing part; and
a pair of first standing-up parts which are extended from both ends in the second direction of the first facing part to the other side in the first direction on both sides in the third direction of the pair of the connection parts, and
the first case-third side plate part and the first case-fourth side plate part are disposed on both sides in the second direction with respect to the pair of the first standing-up parts to structure a second stopper part which restricts a movable range of the yoke in the second direction.

7. The actuator according to claim 5, wherein
the support body comprises:
a first plate which is made of metal and is overlapped with the coil, the first coil holding part and the second coil holding part from the one side in the first direction; and
a second plate which is made of metal and is overlapped with the coil, the first coil holding part and the second coil holding part from the other side in the first direction, and
the connection body comprises:
a first connection body which connects the first facing part with the first plate; and
a second connection body which connects the second facing part with the second plate.

8. The actuator according to claim 3, wherein
the second case member comprises:
a second case-first side plate part which is extended from an end on the one side in the third direction of the second end plate part to the one side in the first direction; and
a second case-second side plate part which is extended from an end on the other side in the third direction of the second end plate part to the one side in the first direction,
the first holder side plate part comprises a first receiving part with which a tip end of the second case-first side plate part is abutted from the other side in the first direction, and
the second holder side plate part comprises a second receiving part with which a tip end of the second case-second side plate part is abutted from the other side in the first direction.
